(19) United States
(12) Patent Application Publication
(10) Pub. No.: US 2006/0057932 A1
(43) Pub. Date: Mar. 16, 2006

(54) Pet toy having intersecting tires

(76) Inventor: James W. Gick, Laguna Niguel, CA (US)

Correspondence Address: CROCKETT & CROCKETT, 24012 CALLE DE LA PLATA, SUITE 400, LAGUNA HILLS, CA, 92653, US

(21) Appl. No.: 11/016,402

(22) Filed: Dec. 17, 2004

Related U.S. Application Data
(63) Continuation-in-part of application No. 10/942,551, filed on Sep. 15, 2004.

(51) Int. Cl. A63H 11/00

(52) U.S. Cl. 446/269

(57) ABSTRACT

A pet toy comprising two intersecting tires. The center of each tire occupies substantially the same point and the axis of one tire is perpendicular to the axis of the other tire.

This application is a continuation-in-part of U.S. application Ser. No. 10/942,551 filed Sep. 15, 2004.

### FIELD OF THE INVENTIONS

The inventions described below relate the field of pet toys.

### BACKGROUND OF THE INVENTIONS

New and improved pet toys are constantly sought in order to better sell pet toys to pet owners. New pet toys should be durable, inexpensive and designed to stimulate a dog, cat or other animal to play with the toy. A well-known type of pet toy is a rubber or plastic ball, such as that shown in Silverglate, Toy Ball Apparatus, U.S. Pat. No. 6,729,984 (May 4, 2004). (Silverglate shows a ball comprising a mesh having a plurality of loop structures forming a spherical surface.)

### SUMMARY

The methods and devices shown below provide for a pet toy in the form of two intersecting rubber tires. The axes of the tires are perpendicular to each other and the center of each tire is also the center of the overall toy. A ball may be disposed in the center of the toy, inside the inner diameter of the tires.

### BRIEF DESCRIPTION OF THE DRAWINGS

FIG. 1 shows a pet toy comprising two intersecting tires.

FIG. 2 shows a pet toy comprising two intersecting tires as seen from the top of the toy.

FIG. 3 shows a pet toy comprising two intersecting tires as seen from the top of the toy with a ball disposed in the inner diameters of the tires.

FIG. 4 shows a pet toy comprising three intersecting tires as seen from the top of the toy.

### DETAILED DESCRIPTION OF THE INVENTIONS

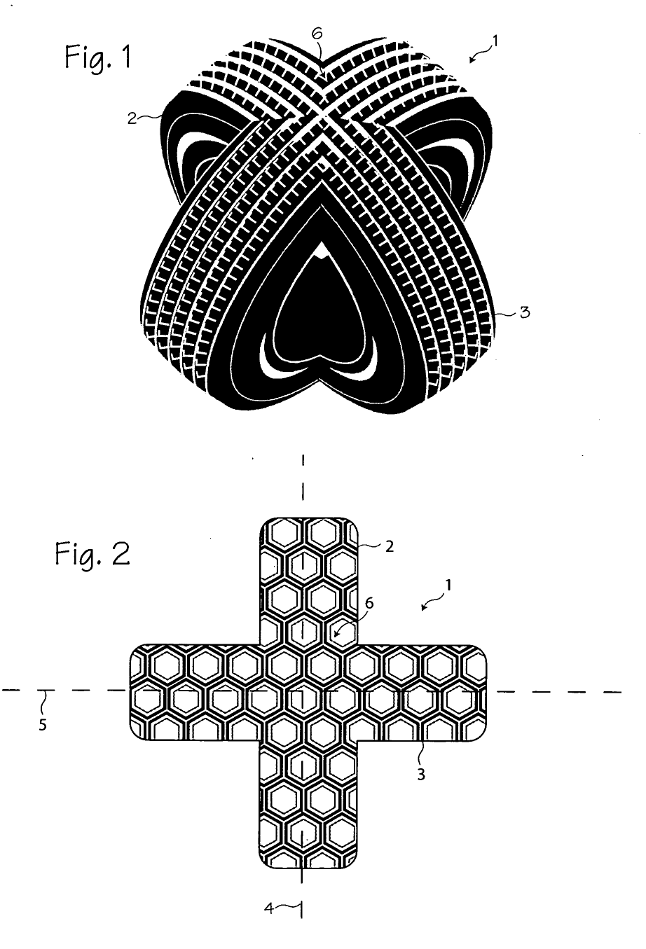

FIGS. 1 and 2 show a pet toy 1 comprising two tires, a first tire 2 and a second tire 3, that intersect such that the center of each tire occupies substantially the same point and is the about same as the center of the toy. The tires are further disposed such that the axis 4 of the first tire is substantially perpendicular to the axis 5 of the second tire.

Although the tires may be made from a variety of materials and may comprise hoops rather than tires, preferably the tires are made from a durable rubber or other thermoplastic or thermoset material with similar properties. Rubber tires roll and bounce well, may be provided with a variety of tread patterns 6 and are tough enough to withstand a dog playing with the toy.

The toy 1 shown in FIGS. 1 and 2 enjoys several advantages over a single tire and over traditional balls. The toy shown in FIGS. 1 and 2 produces an enticing bounce when the rolling toy slows, unlike a ball or a single tire. Also. the toy is easy to grasp, making it easier to retrieve the toy or to grip the toy while a dog grips the other end of a tire, unlike a ball. The interlocking tire shape is enticing to both pets and children as tires are perceived to be durable and easy to roll.

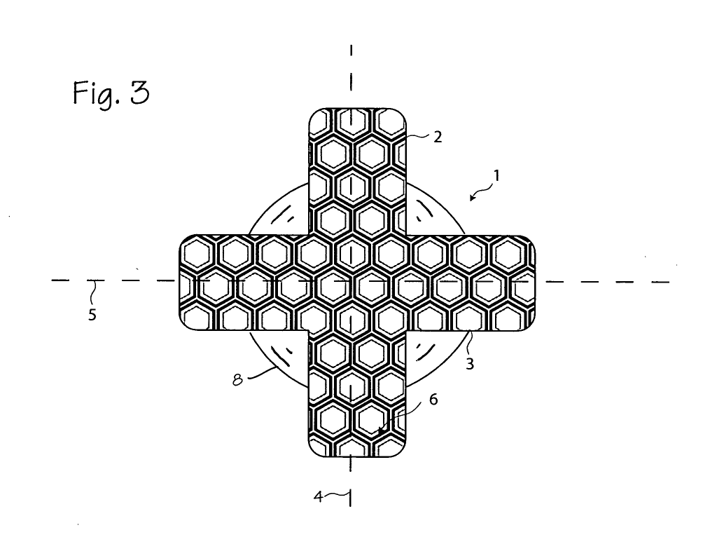

The dual-tire toy may be provided with additional features. For example, the toy may be provided with one or more tread patterns to change how the toy rolls or to help the toy to roll along different kinds of surfaces. Each tire 2 and 3 may be provided with internal belts (much like automobile radial tires) in order to increase the durability of the tires. A second ball or other toy may be provided in the center of the toy (within the inner diameter of each tire) to enhance the appeal of the toy as shown in FIG. 3. The second ball may be sized and dimensioned to bounce within the toy as the toy rolls along a surface. In addition, the toy and the second ball may be painted a variety of attractive colors or marked in a variety of ways. Thus, the toy may be marked and marketed as a children's toy.

In addition, the tire or the second ball may be provided with electronics, speakers and lights that light-up, flash or make noises. An example of balls that may be placed within the toy shown in FIGS. 1 and 2 may be found in my application Ser. Nos. 10/877,917 and 10/877,877. Application Ser. Nos. 10/877,917 and 10/877,877 are fully incorporated within this application by reference. Similar sound or light producing technology may be incorporated within or on the surface of the tires 2 and 3 shown in FIGS. 1 and 2.

FIG. 3 illustrates the pet toy 1 with a second ball 8 disposed within the inner diameters of the tires 2 and 3. The second ball 8, or other object, is provided in the center of the toy (within the inner diameter of each tire) to enhance the appeal of the toy. The second ball or object may produce sounds or emit lights. A light source such as an LED is used to produce light within the second ball 8. A sensor is disposed in the second ball 8, or other object, located within the inner diameters of the tires 2 and 3. The sensor detects motion or vibration. The sensor and its control circuit are highly sensitive such that the second ball 8 or toy within the inner diameters will produce sound, lights, or both sound and lights when the sensor senses that the toy housing has moved, even if moved over a very short distance.

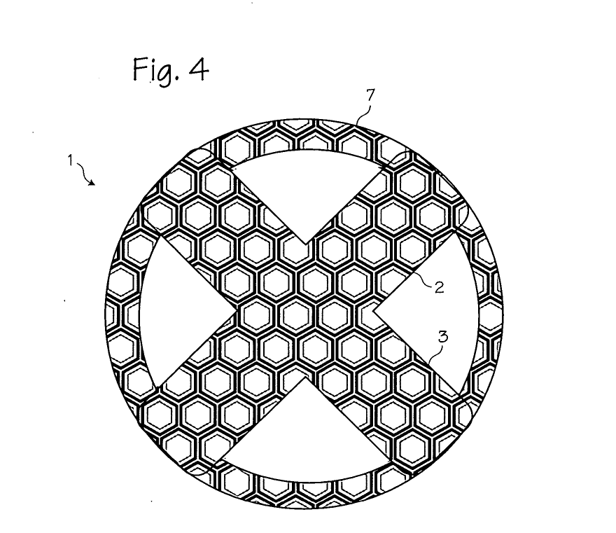

The pet toy 1 may comprise more than two intersecting tires. As shown in FIG. 4, a first tire 2, a second tire 3 and a third tire 7 may intersect ninety degree angles to form the toy.

The toy 1 may comprise more than three intersecting tires whose axes are disposed at various angles relative to each other. Likewise, the angle between the axes of the two tires shown in FIGS. 1 through 4 need not be perpendicular and may vary between a few degrees and 90 degrees. Whatever the configuration of tires, the center of each tire preferably occupies the same point as all of the other tires. However, the centers of each tire may be displaced slightly from the center of the toy in order to change how the ball rolls along a surface.

The toy 1 may be manufactured by any known manufacturing technique. Preferably, the tires are molded together as a unit so that the tires appear to intersect each other, even though the toy is constructed as a single unit. Single unit production may be achieved through rotational molding. Thermoplastics and some thermosets are formed in hollow parts by rotational molding. A mold is made of two pieces and designed to be rotated about two perpendicular axis. Plastic material is placed within the warm mold. The mold is then heated while being rotated. The rotation followed by the heating forces the plastic onto the inner surfaces of the mold where the plastic material then melts and takes the shape of the mold. In this process, the toy can be manufactured as one piece having the intersecting tires and spherical shape as one unitary object. However, the spherical shape may be removed so the inner diameters of the tires remain empty or for placement of a second ball or toy within the inner diameters of the tires.

The tires may also be attached to each other by cutting the tires into appropriate shapes and then adhering or melting them together. In such instances, the tires can be manufactured using compression molding, injection molding, or thermoforming. Regardless of how the toy is manufactured or constructed, the tires may be thought of as being connected together. The tires may be manufactured from a thermoplastic or thermoset. The plastic material used should be pet friendly and not cause irreversible harm if accidentally ingested by a pet.

Thus, while the preferred embodiments of the devices and methods have been described in reference to the environment in which they were developed, they are merely illustrative of the principles of the inventions. Other embodiments and configurations may be devised without departing from the spirit of the inventions and the scope of the appended claims.

We claim:

1. A pet toy comprising:
a first tire having a center, an axis, and an inner diameter;
a second tire connected to the first tire, said second tire having a center, an axis, and an inner diameter;
wherein the axis of the first tire is substantially perpendicular to the axis of the second tire and wherein the center of the first tire and the center of the second tire occupy substantially the same point.

2. The pet toy of claim 1 further comprising a ball disposed within an inner diameter of the first tire and the inner diameter of the second tire.

3. The pet toy of claim 2 wherein the ball further comprises a light source.

4. The pet toy of claim 2 wherein the ball further comprises electronics and speakers.

5. The pet toy of claim 2 wherein the ball further comprises electronics, a light source, and a speaker.

6. The pet toy of claim 1 wherein the first tire and the second tire are manufactured from a polymer.

7. The pet toy of claim 2 wherein the first tire, the second tire, and the ball are one unitary object manufactured from the same material.

8. A pet toy comprising:
a first tire having a center;
a second tire having a center, said second tire connected to the first tire;
a third tire having a center, said third tire connected to the first tire and to the second tire;
wherein the center of the first tire, the center of the second tire and the center of the third tire all occupy substantially the same point.

9. The pet toy of claim 8 further comprising a ball disposed within an inner diameter of the first tire, an inner diameter of the second tire and an inner diameter of the third tire.

10. The pet toy of claim 8 wherein the first tire, the second tire and the third tire are manufactured from a polymer.

11. The pet toy of claim 9 wherein the ball further comprises a light source.

12. The pet toy of claim 9 wherein the ball further comprises electronics and speakers.

13. The pet toy of claim 9 wherein the ball further comprises electronics, a light source, and a speaker.

14. The pet toy of claim 2 wherein the first tire, the second tire, and the ball are one unitary object manufactured from the same material.
